(19) United States
(12) Patent Application Publication
(10) Pub. No.: US 2026/0250515 A1
(43) Pub. Date: Aug. 27, 2026

(54) PROTECTIVE-FILM COMPOSITION AND A METHOD USING SAID COMPOSITION TO FORM A SURFACE LAYER ON A METAL MEMBER

(71) Applicant: TA-WEI CHAO, Taipei City (TW)

(72) Inventor: TA-WEI CHAO, Taipei City (TW)

(21) Appl. No.: 19/209,853

(22) Filed: May 16, 2025

(30) Foreign Application Priority Data
Feb. 21, 2025 (TW) 114106551

(51) Int. Cl. C09D 4/06; B41M 5/00; B41M 7/00; C09D 133/14

(52) U.S. Cl. CPC C09D 4/06; B41M 5/0011; B41M 5/0047; B41M 5/0058; B41M 7/0081; C09D 133/14

(57) ABSTRACT

The present invention relates to a protective-film composition and a method for forming a metal surface layer using said composition. Ingredients of the protective-film composition includes a monomer of β-carboxyethyl acrylate in an amount of 20% to 75% by weight, a photoinitiator in an amount of 5% to 20% by weight, a color paste in an amount of 10% to 40% by weight, and a resin in an amount of 10% to 20% by weight. By loading the protective-film composition into a film-applying device, applying said composition to a metal member having been treated with a pre-treatment liquid, and followed with a two-phased curing process, the metal-surface protective film will be formed thereon. Such a technology makes the protective film characterized by high adhesive capability and excellent durability, and easy to be removed.

### BACKGROUND OF THE INVENTION

### (a) Technical Field of the Invention

The present invention relates to a composition for a protective film, and a method for forming a protective film on the surface of a metal member using said composition;

the protective film completed therewith has increased adhesive capability and excellent durability, and cab be removed easily.

### (b) Description of the Prior Art

During the processing operations of hardware and electronic products (such as mobile phone accessories made of titanium alloy), protection of surface areas not to be processed is very important. As the quality requirements of the non-processed surface areas are generally set at a high degree, any bumps, scratches or other accidental damage to these areas may affect the overall quality and performance of the products.

Currently, in the Computer-Numerical-Control (CNC) processing operation, the surfaces of metal members undergoing processed need to be properly protected according to reasons mentioned above, so as to avoid defects caused by working fluid used in the cutting process, by metal bits, or by processing stress, which may affect the overall quality and performance of the products. At present, the protection methods practically used are mainly conducted by forming a protective layer on the metal surface with traditional ways like spraying, laminating or coating manually. However, regarding the protective layer, there are still problems and defects which need to get improved and are as follows:
First, insufficient adhesive capability: Ink being directly sprayed on the metal member is prone to fall off during the processing operation, affecting its protective effectiveness.
Second, unsatisfied durability: Some ingredients of coatings have limited durability in the working fluid used in the cutting process and cannot withstand the processing treatments for a long-period of time.
Third, hard to be removed: After being processed, the protective layer on the metal surface is hard to be removed, and strong solvents or physical scraping may be used when needed, which will impact badly on the production efficiency.

### SUMMARY OF THE INVENTION

The main purpose of the present invention is to provide a special composition for making a protective film on the surface of a metal member via a CNC processing operation that combines with a two-phased UV-curing process. Such a technology will provide the protective film with advantages of increased adhesive capability and excellent durability, and makes it easy to be removed.

The protective-film composition that can achieve the above-mentioned purpose of the present application includes a monomer of β-carboxyethyl acrylate in an amount of 20% to 75% by weight, a photoinitiator in an amount of 5% to 20% by weight, a color paste in an amount of 10% to 40% by weight, and a resin in an amount of 10% to 20% by weight. The user can load the protective-film composition into a film-applying device, and, at the same time, apply a pre-treatment liquid to a metal member. The protective-film composition loaded in the film-applying device is then to be sprayed on the surface of the metal member by ways of ink-jetting and screen printing, followed with a first-phase curing operation and a second-phase curing operation, so as to complete the formation of the protective film on the surface of the metal member.

By implementing the abovementioned technology, the problems of insufficient adhesive capability, unsatisfied durability, and difficulty in being removed, which are drawbacks associated with the conventional technology, can be overcome, further achieving the practical improvements of the present invention mentioned above.

### BRIEF DESCRIPTION OF THE DRAWINGS

FIG. 1 is a schematic view showing the protective-film compositions according to the first preferred embodiment of the present invention.

FIG. 2 is a flow chart showing the processing steps according to the first preferred embodiment of the present invention.

FIG. 3 is a flow chart showing the processing steps according to the second preferred embodiment of the present invention.

### DETAILED DESCRIPTION OF THE PREFERRED EMBODIMENTS

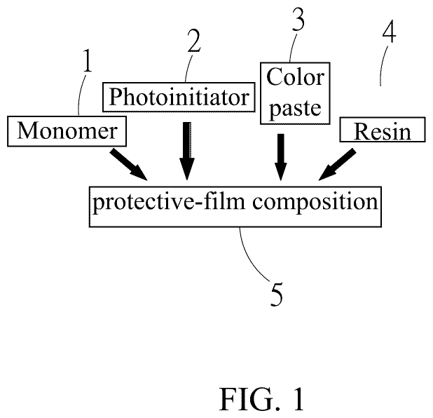

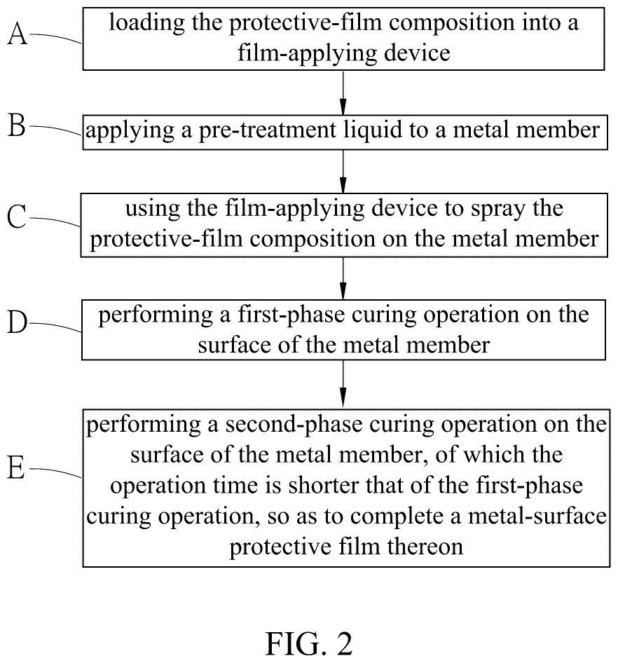

Referring to FIG. 1 and FIG. 2, which are schematic views showing the components of a protective-film composition 5 of the present invention and a flow chart of the processing steps according to the first preferred embodiment of the present invention. It can be clearly seen from these figures that the protective-film composition 5 according to present invention includes:
a monomer 1, in an amount of 20% to 75% by weight, which comprises β-carboxyethyl acrylate; wherein properties of the monomer 1 includes: can be copolymerized with vinyl and acrylic monomers in an emulsion polymerization and irradiation curing system, has a low glass transition temperature, can promote adhesive capability effectively, can improve the stability of the emulsion, has a long carboxylic acid sidechain to provide good flexibility, and promotes more effective interaction between the polymers and the substrate, thereby improving the adhesive capability and peeling strength of the protective film formed therewith, wherein such strength tends to be increased with time;
a photoinitiator 2, in an amount of 5% to 20% by weight, which comprises at least one of the following: bis-(2,4,6-trimethylbenzyl)-phenylphosphine oxide, 2,4,6-trimethylbenzyldiphenylphosphine oxide, 2-hydroxy-2-methyl-1-phenyl-1-propanone, 2-benzyl-2-dimethylamino-1-(4-morpholinophenyl)butanone, 2-(4-methylbenzyl)-2-(dimethylamino)-1-(4-morpholinophenyl)-1-butanone, 2,4-diethylthiazolone and 2-isopropylthioxanthone;
a color paste 3, in an amount of 10% to 40% by weight, wherein the color paste 3 includes a dispersant and a pigment toner; and
a resin 4, in an amount of 10% to 20% by weight, wherein the resin is at least one of the following: polyester resin, polyurethane resin, epoxy resin, chloroacetic acid resin, rosin resin, maleic acid resin, and polyvinyl butyral resin.

Wherein, the monomer 1 includes monomers with monofunctional group and monomers with multifunctional group, and the weight ratio of the monofunctional-group monomers to the multifunctional-group ones is 1:5.

Wherein, the monofunctional-group monomers include at least one of the following: tetrahydrofurfuryl acrylate, cyclotrimethylolpropane formal acrylate, trimethylolcyclohexyl acrylate, ethoxyphenol acrylate, benzyl acrylate, o-phenylphenoxyethyl acrylate, 4-tert-butylcyclohexyl acrylate, dicyclopentenyl acrylate, N,N-dimethylacrylamide, N-acryloylmorpholine, and N-vinylpyrrolidone.

Wherein, the multifunctional-group monomers include at least one of the following: 1,6-hexanediol diacrylate, 1,4-butanediol diacrylate, tripropylene glycol diacrylate, dipropylene glycol diacrylate, triethylene glycol diacrylate, n(ethoxylated) bisphenol A diacrylate, n(ethoxylated) trimethylolpropane triacrylate, n(propoxylated) trimethylolpropane triacrylate, ethoxylated pentaerythritol tetraacrylate, dipentaerythritol hexaacrylate, di(trimethylolpropane) tetraacrylate, pentaerythritol tetraacrylate and dipentaerythritol pentaacrylate.

When to apply the protective-film composition 5 to a metal member for forming a protective film on the surface thereof, processing steps described below can be performed:
(A) loading the protective-film composition 5 into a film-applying device;
(B) applying a pre-treatment liquid to a metal member;
(C) using the film-applying device to apply the protective-film composition 5 therein to the metal member;
(D) performing a first-phase curing operation on the surface of the metal member; and
(E) performing a second-phase curing operation on the surface of the metal member, wherein the curing time of the second-phase curing operation is shorter than that of the first-phase curing operation, so as to complete a protective film on surface of the metal member.

Wherein, the protective-film composition 5 may be applied to the metal member by ways of either ink-jetting or screen-printing, which indicates that the film-applying device may be an ink-jetting printer, a screen printer, or a spray gun. When the film-applying device is an ink-jetting printer, as shown in this embodiment, a platform can be arranged on the film-applying device for placing the metal member. Above the platform, an ink-jetting head, which can move along the XYZ axis thereof, and two light curing devices, for which UV lamps can be used, are provided thereon, along with a control panel to control the ink-jetting head and the light curing devices.

In detail, the metal member, taking titanium alloy as an example, is treated with the pre-treatment liquid first; when this pre-treatment operation is completed, the steps for coating the protective film on surface of the metal member can be performed subsequently. It is noted that, the pre-treatment liquid is composed of phosphate acrylate resin, which exhibits chemical stability and transparency and can increase the hardness, toughness and wear resistance of the material being treated with it. Moreover, the high contents of ethyl acetate included therewith makes it dry quickly and low in toxicity, which can improve the adhesive capability of the metal-surface protective film and avoid the protective film falling off during processing operation, further ensuring the protective film best adhesive capability and making it easy to be peeled when necessary subsequently. The so-called “easy to be peeled” refers to a characteristic of the pre-treatment liquid itself. When the pre-treatment liquid encounters the working fluid used in a cutting process, it will make the protective film easy to be peeled off the surface of the metal member.

After the abovementioned step is completed, the protective-film composition 5 is then loaded into in a film-applying device. (This step is interchangeable with the application of the pre-treatment liquid, indicating that, the protective-film composition 5 can be loaded into the film-applying device first, and then the metal member is treated with the pre-treatment liquid.) At this moment, the user can place the pre-treated metal member on the platform, operate the control panel to start the film-applying device, and make the ink-jetting head move to spray the protective-film composition 5 on the surface of the metal member. After the spraying process is completed, the light curing device is used to irradiate the metal member with ultraviolet light having wavelengths ranging from 365nm to 395nm for performing the first-phase curing operation, which can prevent the protective-film composition 5 from diffusing or flowing, ensuring that the shape of the metal-surface protective film formed thereon is stable. After the irradiating process is completed, the second-phase curing operation is performed with the same light curing device, which, again, irradiates the metal member with ultraviolet light having wavelengths ranging from 365 nm to 395 nm, further ensuring that the metal-surface protective film formed thereon is completely cross-linked, through which its tolerance to the working fluid used in the cutting process will be improved. However, the irradiation time of the second-phase curing operation, about 2 minutes to 3 minutes, is shorter than that of the first-phase curing operation.

Thus, with the abovementioned processing steps, the present invention can provide a technology for forming a highly-effective metal-surface protective film that is suitable for the CNC processing operation. This technology significantly improves the durability of the metal-surface protective film on the metal members, and makes the protective film easy to be peeled when it is subsequently processed with a working fluid used in the cutting process, avoiding the possible defects caused by traditional coating technology. This technology is suitable for aviation, electronics, medicine, precision manufacturing and other fields of industry, and has great market value.

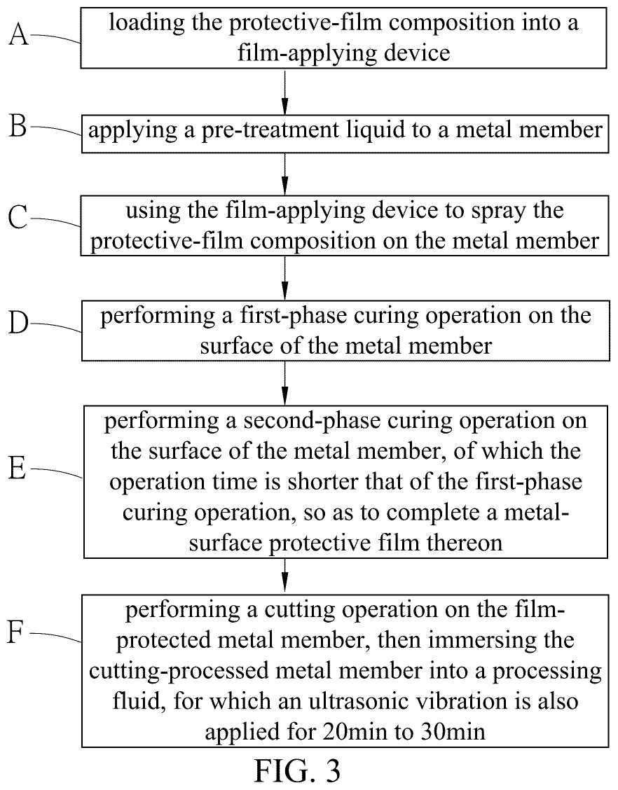

Referring to FIG. 3, which is a flow chart showing the processing steps to be performed in the second preferred embodiment according to the present invention. It can be clearly seen that, the difference existing between this embodiment and the previous one is the arrangement of a step (F) to follow the step (E), where the metal member is processed by cutting and is then immersed in a working fluid used in the cutting process, where the working fluid can be oil-based or water-based coolant. During this immersion operation, ultrasonic vibration is also applied for about 20 minutes to 30 minutes to peel the metal-surface protective film from the metal member. The ultrasonic vibration applied thereto can be either an ultrasonic vibration with warm water or an ultrasonic vibration with a sodium cyanide solvent suitable for treating plastics. As the metal-surface protective film of the present invention is composed of the protective-film composition 5, the metal member being protected by the film can withstand the immersion in the working fluid used in the cutting process for about 6 hours, ensuring that the metal member is protected during the CNC processing operation and for a long-period of time. Besides, the metal-surface protective film will not affect the accuracy of the CNC cutting operation, and can be completely removed in later treatment, leaving no residue on the surface of the metal member and having no impact on subsequent surface treatment (such as anodizing, plating, etc.). Therefore, the metal members suitable for the application of the present invention can be materials able to tolerate high-precision CNC operation, such as aluminum alloy, titanium alloy, stainless steel, copper, and magnesium alloy.

In a summary, the keys that the protective-film composition and the method of using said composition to form a surface layer on a metal member provided in the present invention can overcome the drawbacks of conventional technology are based on the following features:

First, a protective-film composition 5 is provided in the present invention by combining together a monomer 1 of β-carboxyethyl acrylate in an amount of 20% to 75% by weight, a photoinitiator 2 in an amount of 5% to 20% by weight, a color paste 3 in an amount of 10% to 40% by weight, and a resin 4 an amount of 10% to 20% by weight. The application of said composition to form a protective film on the surface of a metal member results in a metal-surface protective film possessing with high adhesive capability and excellent durability, and being easy to be removed.

Second, since the metal-surface protective film described in the present invention is mainly composed of the protective-film composition 5, the metal member being protected can withstand the immersion in the working fluid used in the cutting process for about 6 hours, ensuring that the metal member is protected during the CNC processing operation and for a long-period of time. Also, the metal-surface protective film will not affect the accuracy of the CNC cutting operation, and can be completely removed in later treatment, leaving no residue on the surface of the metal member and having no impact on subsequent surface treatment.

Third, through the provision of a first-phase curing operation, the protective-film composition 5 applied to the surface of the metal member can be prevented from diffusing or flowing, ensuring that the shape of the metal-surface protective film is stable. Further, through the provision of a second-phase curing operation, it is ensured that the metal-surface protective film can be completely cross-linked, thereby improving its tolerance to the working fluid used in the cutting process.

Fourth, through the design of the monomer 1, the photoinitiator 2, and the resin 4, the surface-protective film completed by melting these ingredients together will be good in its plasticity, chemical resistance, transparency, impact resistance, and weather tolerance. It is also safe and not harmful to the metal members being processed. As the materials used for making the protective film is weakly acidic, the protective film formed therewith will not corrode or damage the metal members.

Fifth, through the arrangements of an ink-jetting head able to move along the XYZ axis thereof and a film-applying device with two light-curing apparatuses, the spraying and printing processes can be accurately performed, further saving costs efficiently and reducing unnecessary wastes.

Sixth, as the pre-treatment liquid provided in the present invention is highly excellent in its chemical stability, transparency and tolerance to ultraviolet light irradiation, which is particularly important when the metal members are immersed in the working fluid used in the cutting process, it can provide the metal-surface protective film with the property of being easy to be removed, making the film fall off by itself and without residue.

Seventh, the resin provided therein can increase the hardness, toughness and resistance to abrasion of the metal-surface protective film formed therewith.

I claim:

1. A protective-film composition, comprising:
a monomer, which comprisesβ-carboxyethyl acrylate in an amount of 20% to 75% by weight;
a photoinitiator, in an amount of 5% to 20% by weight;
a color paste, in an amount of 10% to 40% by weight; and
a resin, in an amount of 10% to 20% by weight.

2. The protective-film composition according to claim 1, wherein the monomer comprises at least one of the following: tetrahydrofurfuryl acrylate, cyclotrimethylolpropane formal acrylate, trimethylolcyclohexyl acrylate, ethoxyphenol acrylate, benzyl acrylate, o-phenylphenoxyethyl acrylate, 4-tert-butylcyclohexyl acrylate, dicyclopentenyl acrylate, N,N-dimethylacrylamide, N-acryloylmorpholine and N-vinylpyrrolidone.

3. The protective-film composition according to claim 1, wherein the photoinitiator comprises at least one of the following: bis(2,4,6-trimethylbenzyl)phenylphosphine oxide, 2,4,6-trimethylbenzyldiphenylphosphine oxide, 2-hydroxy-2-methyl-1-phenyl-1-propanone, 2-benzyl-2-dimethylamino-1-(4-morpholinophenyl)butanone, 2-(4-methylbenzyl)-2-(dimethylamino)-1-(4-morpholinophenyl)-1-butanone, and 2,4-diethylthiazolone and 2-isopropylthioxanthone.

4. The protective-film composition according to claim 1, wherein the color paste includes a dispersant and a pigment powder.

5. The protective-film composition according to claim 1, wherein the resin comprises at least one of the following: polyester resin, polyurethane resin, epoxy resin, chloroacetic acid resin, rosin resin, maleic acid resin, and polyvinyl butyral resin.

6. A method for forming a surface protective film on a metal member, of which steps comprise:
(a) loading the protective-film composition according to claim 1 into a film-applying device;
(b) applying a pre-treatment liquid to a metal member;
(c) using the film-applying device to spray the protective-film composition on the metal member;
(d) performing a first-phase curing operation on the surface of the metal member; and
(e) performing a second-phase curing operation on the surface of the metal member, wherein the operation time of the second-phase curing operation is shorter the ones of the first-phase curing operation, so as to complete a surface protective film on the metal member.

7. The method for forming a surface protective film on a metal member according to claim 6, wherein, after completing the second-phase curing operation, the metal member can be processed by cutting; then the metal member resulted therefrom is immersed in a working fluid used in a cutting process, where an ultrasonic vibration is applied to make the metal-surface protective film fall off the metal member.

8. The method for forming a surface protective film on a metal member according to claim 7, wherein the ultrasonic vibration applied thereto can be either an ultrasonic vibration with warm water or an ultrasonic vibration with a sodium cyanide solvent suitable for treating plastics.

9. The method for forming a surface protective film on a metal member according to claim 6, wherein the protective-film composition is disposed on the metal member by means of either ink-jetting or screen printing.

10. The method for forming a surface protective film on a metal member according to claim 6, wherein the first-phase curing operation and the second-phase curing operation are performed using a light-curing device, and the light-curing device can emit ultraviolet light with wavelengths ranging from 365 nm to 395 nm.
